(19) United States
(12) Patent Application Publication
(10) Pub. No.: US 2014/0356165 A1
(43) Pub. Date: Dec. 4, 2014

(54) WIND TURBINE BLADES WITH AIR PRESSURE SENSORS

(71) Applicants: Wei Xiong, Shanghai (CN); Danian Zhang, Simpsonville, SC (US); Xiongzhe Huang, Shanghai (CN); Jing Wang, Simpsonville, SC (US); Jingyun Xia, Shanghai (CN)

(72) Inventors: Wei Xiong, Shanghai (CN); Danian Zhang, Simpsonville, SC (US); Xiongzhe Huang, Shanghai (CN); Jing Wang, Simpsonville, SC (US); Jingyun Xia, Shanghai (CN)

(21) Appl. No.: 14/005,282

(22) PCT Filed: Mar. 14, 2011
(86) PCT No.: PCT/CN2011/000395

§ 371 Date: Apr. 21, 2014

(51) Int. Cl. F03D 11/00; G01L 13/00; F03D 7/04

(52) U.S. Cl. CPC F03D 11/0091; F03D 7/042; G01L 13/00
USPC 416/61; 73/700

(57) ABSTRACT

A wind turbine blade has a suction side shell member and a pressure side shell member. The shell members are joined along a leading and trailing edge from a root to a tip of the blade and defining an internal cavity of the blade. A pressure sensor is configured on at least one of the suction or pressure side shell members. The pressure sensor further includes a body mounted to an inner surface of the respective shell member within the internal cavity. A sensing element has a first side exposed to external air pressure through a passage in the respective shell member, and an opposite second side exposed to a reference pressure. Control circuitry within the body generates a variable output signal as a function of a pressure differential between the external air pressure and reference pressure experienced by the sensing element.

### FIELD OF THE INVENTION

The present subject matter relates generally to wind turbine blades, and particularly to wind turbine rotor blades having pressure sensors incorporated therein.

### BACKGROUND OF THE INVENTION

Measurement of the dynamic pressure of air flow over a wind turbine blade is useful for various reasons, such as an indication of blade performance, pitch control, load control, stall detection, and so forth. U.S. Pat. Appln. Pub. No. 2010/0021296 describes use of a plurality of pressures sensors arranged on the suction and pressure sides of a wind turbine blade to determine the angle-of-attack of the wind acting on the blade. The angle-of-attack measurement is used to adjust the pitch of the blade to optimize the wind turbine performance.

Conventional mechanical pressure sensors generally have drawbacks for use on wind turbine blades. For example, piezo/strain-based pressure sensors that require a diaphragm to measure the pressure-induced stress and strain generally require sizable ducts or penetrations in the blade structure to accommodate the diaphragm package. This complicates the blade construction process. Also, with such instruments, the pressure typically needs to be introduced into the sensor diaphragm by a nozzle and a tube, causing the directionality of the pressure measurement to be further limited. Any structure that extends above the blade's external surface also tends to adversely affect the aerodynamic performance of the blade.

Accordingly, there is a need for simplified incorporation of a reliable and aerodynamic pressure sensor in wind turbine blades that does not adversely impact the integrity and fluid dynamic performance of the blade.

### BRIEF DESCRIPTION OF THE INVENTION

Aspects and advantages of the invention will be set forth in part in the following description, or may be obvious from the description, or may be learned through practice of the invention.

In one aspect, a wind turbine blade is provided with a suction side shell member and a pressure side shell member. The shell members are joined along a leading and trailing edge from a root to a tip of the blade and define an internal cavity of the blade. A pressure sensor is configured on at least one of the suction side or pressure side shell members. Pressure sensors may be provided in any desired pattern on both of the pressure and suction side shell members. The pressure sensor includes a body mounted to an inner surface of the respective shell member within the internal cavity. The pressure sensor includes a sensing element having a first side exposed to external air pressure through a passage in the respective shell member, and an opposite second side exposed to a steady-state reference pressure. Control circuitry within the body generates a variable output signal as a function of a pressure differential experienced by the sensing element.

In a particular embodiment, the pressure sensor includes a tubular member that extends from the body into the passage in the respective shell member. The passage may be pre-formed (e.g., molded or cut) in the shell member. The tubular member has an open end in fluid communication with external air pressure via the passage. The open end may extend so as to be essentially flush with the external surface of the shell member. The sensing element may be disposed within the tubular member.

The reference pressure may be supplied to the sensing element by various means. For example, the pressure sensor may include a reference pressure conduit that extends from the body and is in fluid communication with the opposite second side of the sensing element through the sensor body. The reference pressure conduit may be in fluid communication with ambient air within the internal cavity, whereby the reference pressure is the ambient air within the internal cavity. In a particular embodiment, each individual pressure sensor may have a reference pressure conduit in the form of a tube with an end that is open to the internal cavity. In an alternate embodiment, the reference pressure conduits from a plurality of different pressure sensors may be connected to a common header that is, in turn, open to the internal cavity of the blade.

In an alternate embodiment, the reference pressure conduit is in fluid communication with the external air pressure at the opposite shell member such that reference pressure is the external air pressure acting on opposite shell member.

The pressure sensors may be in communication with a controller via any suitable wired or wireless configuration, with the controller using the output signal for control or measurement of a wind turbine parameter, such as load control, pitch control, stall detection, and so forth. In an embodiment wherein the blade includes a plurality of the pressure sensors, a data acquisition terminal may be incorporated with the blade and used to collect/process the signals from the sensors and transmit the signals to the wind turbine controller.

A plurality of the pressure sensors may be arranged in a predetermined pattern on either or both of the suction side and said pressure side shell members. This pattern may be theoretically derived, calculated, or empirically determined to produce optimal pressure signals and control parameters. For example, the pressure sensors may be configured in a plurality of spaced apart (in the longitudinal direction of the blade) full chord-wise spans from the root to the tip of the blade on each of the suction side and pressure side shell members. Alternatively, the sensors may be configured in a plurality of spaced apart full chord-wise spans distributed over one of an inner ⅓ axial section, a middle ⅓ axial section, or an outer ⅓ axial section of the blade (including a tip section).

In still further embodiments, the pressure sensors may be configured in a plurality of spaced apart partial chord-wise spans along the blade. For example, the partial chord-wise spans may be configured at one of the trailing edge or leading edge of a single respective shell member, at one of the trailing edge or leading edge of both respective shell members, or at the trailing edge and leading edge of both respective shell members.

The invention also encompasses a wind turbine having one or more turbine blades configured with pressure sensors as described herein.

The invention also encompasses various method embodiments for measuring the pressure of air flowing over a wind turbine blade. Particular method embodiments include defining a passage through a suction side or pressure side shell member and locating a pressure sensor in fluid communication with the passage such that no part of the pressure sensor extends onto an external surface of the shell member. A first side of a sensing element of the pressure sensor is exposed to external air pressure through the passage and a second opposite side of the sensing element is exposed to a reference pressure, which may be steady-state air within an internal cavity of the blade or the external air pressure acting on the opposite shell member. An output signal is generated from the pressure sensor that is indicative of the external air pressure.

In particular method embodiments, a body of the pressure sensor is mounted on an internal surface of the shell member over the passage and the sensing element is disposed within the passage. For example, the sensing element may be configured within a tube that extends into the passage.

The method embodiments may further include locating a plurality of the pressure sensors in a defined pattern on either or both of the suction side and pressure side of the blade, depending on the particular areas of the blade desired to be monitored.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine with one or more blades in accordance with aspects of the invention;

FIG. 2 is a diagrammatic view of the suction and pressure sides of an exemplary wind turbine blade illustrating placement of pressure sensors;

FIGS. 3 through 6 illustrate various placement embodiments of chord-wise spans of pressure sensors on wind turbine blades;

FIG. 7 is a side cut-away view of a wind turbine blade with pressure sensors in a stall condition;

FIGS. 8 and 9 are side cut-away views of embodiments of partial chord-wise spans of pressure sensors on wind turbine blades;

FIG. 10 is a perspective view of embodiments of differential pressure sensors;

FIG. 11 is a side cut-away view of a differential pressure sensor mounted in a shell member;

FIG. 12 is a side cut-away view of a wind turbine blade with common reference pressure headers for the differential pressure sensors;

FIG. 13 is a side cut-away view of a wind turbine blade with an alternative embodiment of common reference pressure headers for the differential pressure sensors;

FIG. 14 is a side cut-away view of a wind turbine blade with individual reference pressure conduits for the respective differential pressure sensors;

FIG. 15 is a side cut-away view of an alternative embodiment of a wind turbine blade with respective differential pressure sensors on the pressure and suction sides that take a reference pressure from the opposite external blade side; and,

FIG. 16 is a side cut-away view of an embodiment similar to FIG. 15 wherein the differential pressure sensors share a common header that is in fluid communication with the opposite external blade side.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

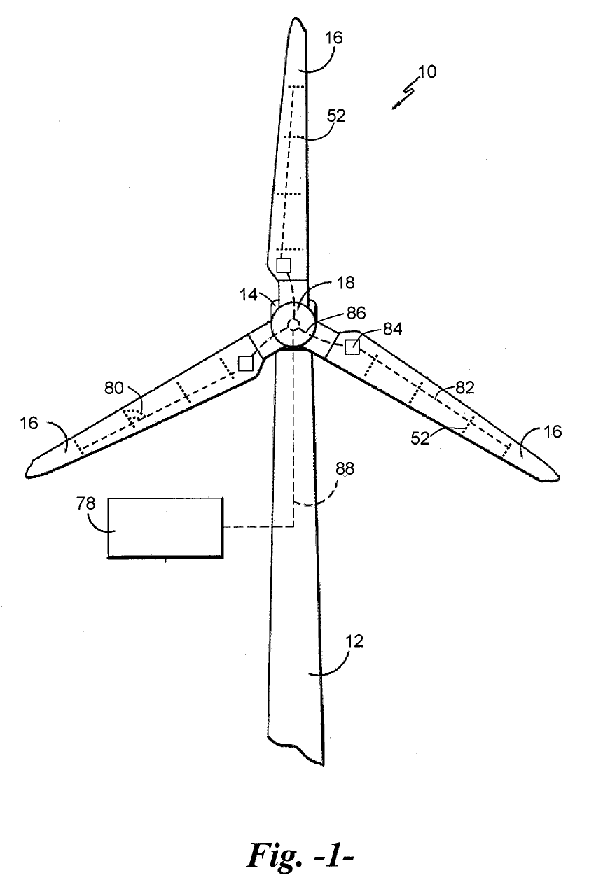

Referring to the drawings, FIG. 1 illustrates a perspective view of a horizontal axis wind turbine 10. It should be appreciated that the wind turbine 10 may be a vertical-axis wind turbine. The wind turbine 10 includes a tower 12, a nacelle 14 mounted on the tower 12, and a rotor hub 18 that is coupled to a generator within the nacelle 14 through a drive shaft and gearing. The tower 12 may be fabricated from tubular steel or other suitable material. The rotor hub 18 includes one or more blades 16 coupled to and extending radially outward from the hub 18. The blades 16 may generally have any suitable axial length that enables the wind turbine 10 to function according to design criteria. For example, the blades 16 may have a length ranging from about 15 meters (m) to about 91 m. The blades 16 rotate the rotor hub 18 to enable kinetic energy to be transferred from the wind into usable mechanical energy, and subsequently, electrical energy.

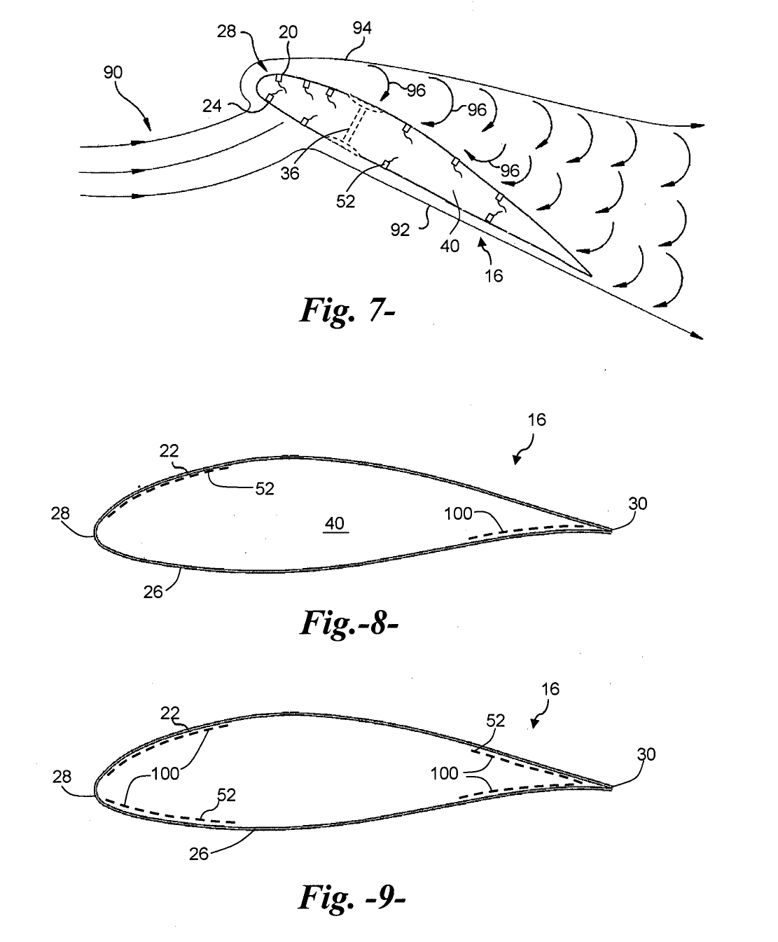

Referring to FIG. 2, each of the blades 16 includes shell members 22, 26 joined at a leading edge 28 and a trailing edge 30. The shell members 22, 26 define an internal cavity 40 (FIG. 7) of the blade. Shell member 22 defines the suction side 20 of the blade 16, and shell member 26 defines the pressure side 24. Each blade 16 includes a longitudinal axis 104 extending between a root portion 32 and a tip portion 34. Any manner of internal support structure, such as a shear web 36 and spar caps 38 (FIG. 12), are located within an internal cavity 40 of the blade 16.

As shown in FIG. 1, the wind turbine 10 may also include a turbine controller or control system 78 located within the nacelle 14 or at any location on or in the wind turbine 10, or generally at any other suitable location. The controller 78 may include suitable processors and/or other processing functionality configured to perform any manner of control or monitoring function associated with the wind turbine 10. For example, the controller 78 may be configured as a computer or other central processing unit having various input/output channels and/or devices for receiving inputs from sensors (particularly pressure sensors as described herein) and other measurement devices, and for sending control signals to various components of the wind turbine. By executing control commands, the controller 78 may be configured to control the various operating modes of the wind turbine 10 (e.g., start-up or shut-down sequences). The controller 78 may also be configured to control the blade pitch or pitch angle of each of the blades 16 to control the load and power generated by the wind turbine 10 by transmitting suitable control signals to a pitch drive or pitch adjustment system within the nacelle 14. Further, as the direction of the wind changes, the controller 78 may be configured to control the position of the nacelle 14 relative to a yaw axis via a yaw drive mechanism within the nacelle 14 to position the rotor blades 16 with respect to the wind direction.

It should be appreciated that the invention is not limited to any particular use of functionality associated with the signals generated by the pressure sensors 52. For example, any manner of actuator or aerodynamic control surface may be controlled as a function of the signals form the pressure sensors 52, including a spoiler, winglet, deployable vortex generators, actuatable openings in the blade surface, and so forth.

Still referring to FIG. 1, each of the blades 16 includes a plurality of pressure sensors 52 (described in greater detail below) configured in a predetermined pattern thereon. The pressure sensors 52 may be operatively configured on either of the suction side 20 or pressure side 24 (FIG. 2) of the blade 16, or on both of the suction and pressure sides 20, 24. Alternatively, less than all of the blades 16 may be configured with the pressure sensors 52. The pressure sensors 52 provide respective signals that are indicative of the external air pressure flowing over the surface of the blade in the vicinity of the sensor 52. For example, referring to FIG. 7, a blade 16 is illustrated in an incident airstream 90 that impinges on the leading edge 28 of the blade and flows around the suction side 20 and pressure side 24 of the blade. The blade 16 is at a significant angle-of-attack (AOA) relative to the incident airstream 90 such that the blade 16 is in a stall condition. Smooth airflow 92 flows along the pressure side 24, but a flow separation 94 is generated in the airflow over the suction side 20 causing a turbulent wake 96. A plurality of pressure sensors 52 are arranged in a chord-wise span on the suction 20 and pressure 24 sides, respectively. Pressure measurements by the sensors 52 may be used by the controller 78 to diagnose the stall condition, or to control the blade to prevent or generate a stall condition, or for any other manner of control function related to the aerodynamic performance of the blade 16, for example to reduce load or even brake the rotor 18.

Referring still to FIG. 1, the plurality of pressure sensors 52 may be in communication with the controller 78 by any suitable wired or wireless transmission means. In the illustrated embodiment, the sensors 52 have individual signal conductors 80 that connect to any suitable conductor 82 within, on, or attached to the blade 16. For example, in embodiments wherein pressure sensors 52 are fiber optic strain sensors, the conductor 82 may be a bundle of sensor cables disposed within the blade or within an insert attached to the blade, for example a trailing edge insert. The signal conductors 80 may be defined by wires (including fiber optic cables) laid out on the blade surface or embedded in the blade, with the wires connected (e.g., with individual leads) to the conductor 82 along the trailing edge 30. Alternatively, the individual conductors 80 from the plurality of sensors 52 may be combined in a wire bundle that runs longitudinally within the blade.

The conductor 82 may, in turn, be in communication with a data acquisition terminal (DAT) 84 that may be permanently mounted within the blade 16. The DAT 84 may transmit the signals wirelessly (in any suitable signal form) to the controller 78, or via wired transmission through a conductor 86 and slip ring configuration, or other suitable conductive transmission path. The DAT may process the signals form the pressure sensors 52 before transmission to the controller 78, and may store data for later download to the controller 78 or test/diagnostic equipment.

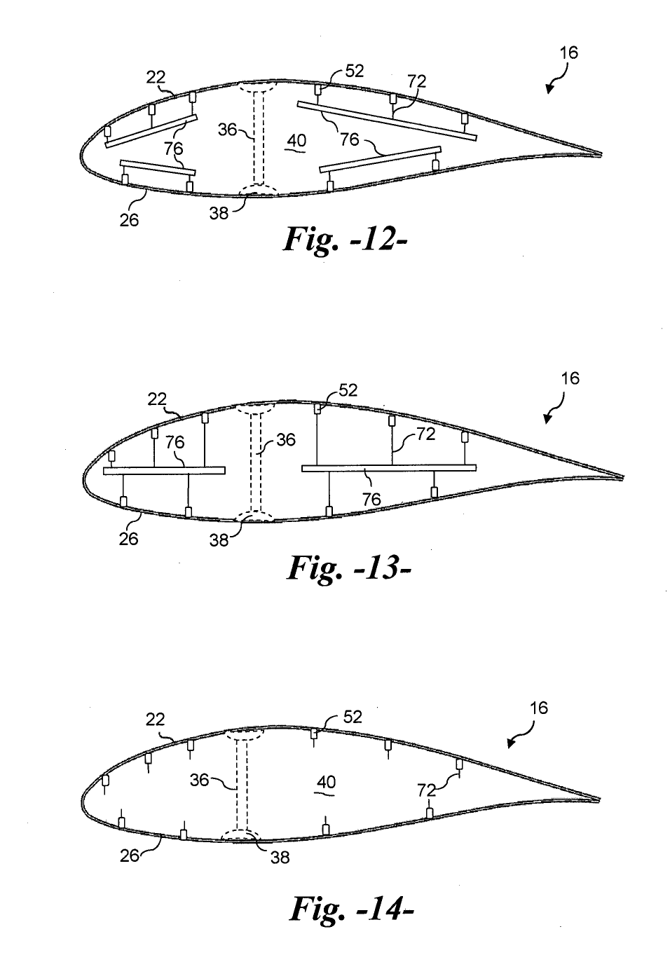

FIGS. 10 and 11 illustrate a particular embodiment of a pressure sensor 52 that may be utilized with the wind turbine blade 16 in accordance with embodiments of the invention. In this embodiment, the pressure sensors 52 are differential pressure sensors that include a body 54 in which any combination of the functional and control components of the sensor 52 are housed. The housing 54 is depicted as a cylindrical member for illustrative purposes only. The body 52 may be configured for mounting to an inner surface 46 within the internal cavity 40 the blade 16 of the suction or pressure side shell members 22, 26 by any mounting means, including any suitable adhesive compound or other material 42. The sensor 52 includes a differential pressure sensing element 56 with a first side 58 that is exposed to external air pressure and a second side 60 that is exposed to a steady-state reference pressure. In the illustrated embodiment, the first side 58 is exposed to external air pressure through a passage 50 defined through the shell member 22, 26. For example, the sensing element 56 may be operatively disposed within a tubular member 68 that is inserted into the passage 50. In a particular embodiment, the tubular member 68 has an axial length with an open end 70 so as to extend essentially completely through the shell member 22, 26, with the open end 70 being essentially flush with the external surface 48 of the shell member 22, 26. Any manner of suitable adhesive compound or filler 42 may be used to seal around the tubular member 68 at the external surface 48 or along the entire axial length of the tubular member 68 within the passage 50. As depicted in FIG. 11, the incident air stream 90 that flows over the external surface 48 of the shell member 22, 26 has an air pressure that acts against the first side 58 of the sensing element 56, as depicted by the arrow 91 in FIG. 11.

The passage 50 may also be filled with a weatherproof material to protect the pressure sensing element 56. This material would be a generally incompressible pressure transmission medium, such as a silicone-based material.

The second side 60 of the sensing element 56 is exposed to a steady-state reference pressure. In the illustrated embodiment, the second side 60 is in fluid communication with the ambient air within the internal cavity 40 of the blade via a reference pressure conduit 72. In the illustrated embodiment, this conduit 72 may be defined by a tube 74 that extends from the body 54 and has an end that is open to the internal cavity 40. The tube 74 has an opposite end that is open to the body 54 such that the interior space of the body 54 is at the ambient air pressure within the internal cavity 40, as depicted in FIG. 11. The opposite end 71 of the tubular member 68 is also in fluid communication with the interior space of the body 54 and, thus, the second side 60 of the sensing element 56 is exposed to the same ambient air pressure.

It should be readily appreciated that the configuration illustrated in FIGS. 10 and 11 is but one of any number of suitable configurations that may be used for supplying a steady-reference pressure to the sensing element 56 while also exposing the sensing element 56 to external air pressure. The invention is not limited to the particular configuration of the pressure sensor 52 illustrated in FIGS. 10 and 11.

In particular embodiments, the pressure sensor 52 operates as a differential pressure strain detector wherein the strain induced on the sensing element 56 as a result of the pressure difference between the external pressure and the internal steady state pressure is detected and used to generate a corresponding signal that is indicative of the external air pressure. In a particular embodiment, the sensor 52 may be an optical fiber strain detector. The use of optical fibers to detect strain in members due to a pressure applied to the member is known in the art and need not be described in detail herein. Reference is made to U.S. Pat. No. 7,159,468 for a description of various embodiments of an optical fiber differential pressure sensor that may be used in embodiments of the present invention.

In still alternate embodiments, the pressure sensor 52 may incorporate a piezo-resistive pressure transducer wherein the sensing element 56 is a silicon piezo-resistive member that is fixed and sealed within the tubular member 68. A lead 64 connects the piezo-resistive sensitive component 56 to control circuitry 62 within the body 54. The sensing element 56 may incorporate a wheatstone electrical bridge circuit that generates and transmits a resistive signal via the lead 64 to the control circuitry 62 as a function of the strain induced on the sensing element 56 as a result of the differential pressures between external air pressure and the steady state reference pressure on the opposite sides of the sensing element 56. Control circuitry 62 generates an output signal that is transmitted via the signal conductor 80, as discussed above.

Piezo-resistive strain detectors that may be utilized in a pressure sensor 52 in accordance with the aspects discussed above are available from Kunshan Shuangqiao Sensor Measurement Controlling Co., Ltd. of China.

In alternative embodiments, the differential pressure sensor 52 may be a thermo-anemometer micro flow sensor. These types of devices are generally used for accurate sensing of low differential pressures. Examples of these types of sensors are commercially available from Microbridge Technologies Canada, Inc.

It should be appreciated that the pressure sensors 52 in accordance with aspects of the invention are not limited to any particular operating principle. The sensors 52 are, in certain embodiments, differential pressure sensors having a detection range and accuracy that is suitable for wind turbine external air pressure sensing, as discussed herein. Other types of sensing principles may also be utilized, including flow sensors, LVDT (linear variable differential transformer) detectors, electromagnetic sensors, and so forth.

As discussed above, a turbine blade 16 in accordance with aspects of the invention may include a plurality of the pressure sensors 52 arranged in a predetermined pattern on either or both of the suction side 20 or pressure side 24 of the blade. In FIG. 2, the suction side 20 and pressure side 24 of a blade are depicted for a blade 16 having an overall length indicated by the hash-marked reference line 98. In this particular embodiment, a full chord-wise span 100 of the pressure sensors 52 is located at four distinct locations along the longitudinal axis 104 of the blade. In the depicted embodiment, a first chord-wise span 100 is located at 14 meters (m) from the root 32. The next chord-wise span 100 is located at 21 meters. The third chord-wise span 100 is located at 28 meters. The final chord-wise span 100 is located at 33 meters from the root 32. Each of the chord-wise spans 100 is configured at an offset angle relative to the chord axis 102. In the depicted embodiment, this offset is about fifteen degrees, as depicted in FIG. 2. It should be readily appreciated that location of the chord-wise spans 100 along the longitudinal axis 104 may vary depending on blade size, configuration, aerodynamic profile, and the like. The chord-wise spans 100 may be located at various positions or locations on the blade 16 that are of particular interest for external pressure monitoring. It should also be appreciated that the chord-wise spans 100 are not limited to any particular arrangement or pattern of sensors 52 within the respective span.

In the embodiment of FIG. 2, the chord-wise spans 100 are considered “full” in that each span 100 includes a plurality of the pressure sensors disposed so as to essentially monitor pressure from the leading edge 28 to the trailing edge 30 of the respective blade surface 20, 24. The full chord-wise spans 100 may be distributed over defined sections of the blade 16. For example, in the embodiment of FIG. 3, the chord-wise spans 100 are spaced apart along a longitudinal section 106 corresponding to the outer (adjacent the tip 34) one-third axial section of the blade 16. In the embodiment of FIG. 4, the longitudinal section 106 is focused primarily at the tip 34 of the blade.

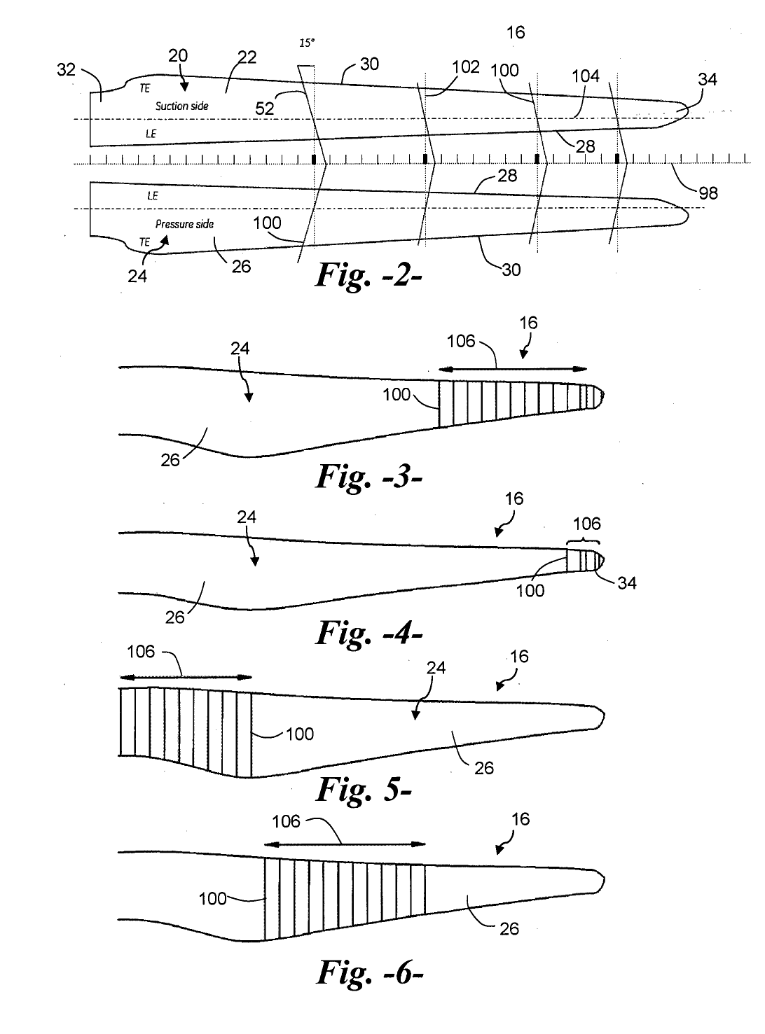

In the embodiment of FIG. 5, the longitudinal section 106 of chord-wise spans 100 is distributed over the inner one-third axial section of the blade 16.

In the embodiment of FIG. 6, the longitudinal section 106 of chord-wise spans 100 is distributed over the middle one-third axial section of the blade 16. It should be appreciated that a longitudinal section 106 includes any distribution of chord-wise spans 100 within the section. For example, an inner one-fourth axial section of the blade is encompassed by the one-third axial section. Likewise, the blade tip longitudinal section 106 depicted in FIG. 4 is encompassed within the outer one-third axial section of FIG. 3.

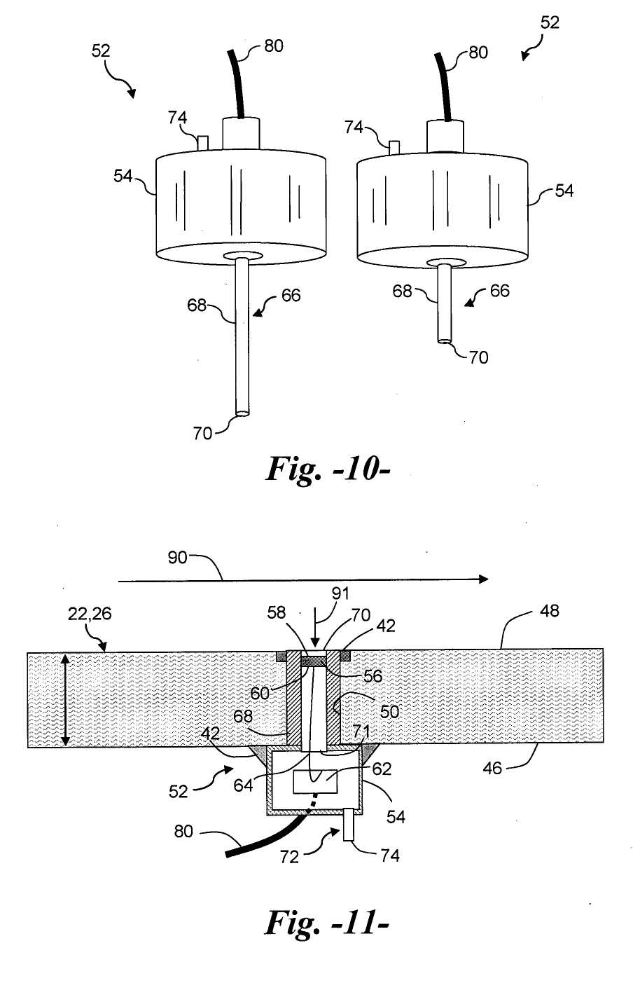

The pressure sensors 52 may also be distributed on the blade surface in less than full chord-wise spans 100. For example, referring to FIGS. 8 and 9, partial chord-wise spans 100 are indicated. In the embodiment of FIG. 8, a partial chord-wise span 100 is configured at the leading edge 28 of the suction side shell member 22. An additional partial chord-wise span 100 is configured at the trailing edge 30 of the pressure side shell member 26. It should be appreciated that the partial chord-wise spans may be variously located. For example, the configuration in FIG. 8 could be reversed such that the leading edge partial chord-wise span 100 is configured on the pressure side shell member 26 and the trailing edge span 100 is configured on the suction side shell member 22. Likewise, referring to FIG. 9, leading edge partial chord-wise spans 100 may be configured at the leading edge 28 of both shell members 22, 26 and at the trailing edge 30 of both shell members.

FIGS. 12 through 14 depict various configurations for supplying the steady-state reference pressure to the individual pressure sensors 52. In the embodiment of FIG. 12, the pressures sensors 52 configured at the leading edge of the shell member 22 share a common header 76 that is open to the internal cavity 40. Likewise, the pressure sensors 52 on the shell member 22 closer to the trailing edge share a different common reference header 76. The sensors 52 along the opposite shell member 26 also have different respective common reference headers 76. The common reference headers 76 do not pass through the shear web 36 for structural and manufacturing considerations.

In the embodiment of FIG. 13, all of the pressure sensors 52 on one side of the shear web 36 share a common reference header 76, while all of the pressure sensors 52 on the opposite side of the shear web 36 share a different respective common header 76.

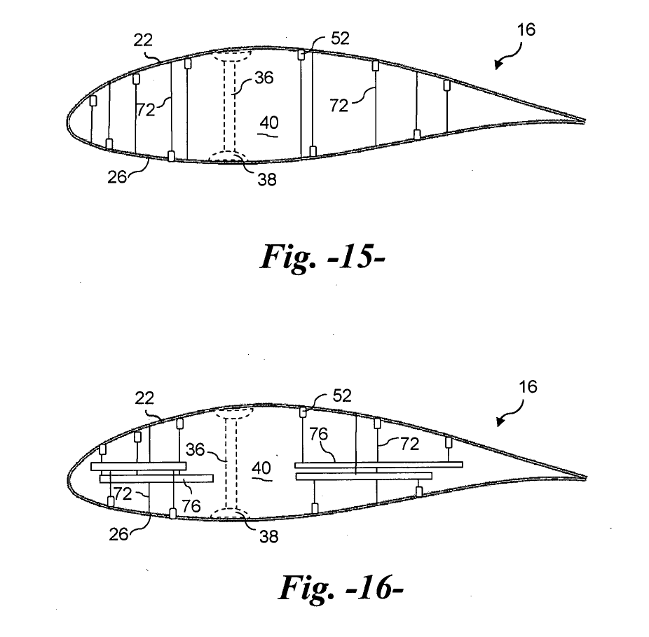

In the embodiment of FIG. 14, each of the individual pressure sensors 52 includes an individual reference pressure conduit 72 that may be, as discussed above, a tubular member that has one end open to the internal cavity 40 and then opposite and in communication with the sensor body.

FIGS. 15 and 16 illustrate an alternate embodiment of a wind turbine blade 16 wherein the differential pressure sensors 52 utilize the external air pressure at the opposite side of the blade 16 as a reference pressure. Referring to FIG. 15, the sensors 52 configured on the suction side shell member 22 include a reference pressure conduit 72 that extends through the internal cavity 40 of the blade and is fluid communication with the external side of the opposite pressure side shell member 26, for example via a passage in the shell member 26. For example, the end of the conduit 72 may mate with a connector (not illustrated) configured at a passage (e.g., port, tube, channel, or the like) defined through the shell member 26. Alternatively, the conduit 72 may extend through such a passage. Similarly, the pressure sensors 52 configured on the pressure side shell member 26 have reference pressure conduits 72 that are in fluid communication with the external side of the opposite suction side shell member 22. The location of the reference pressure conduits 72 on the opposite shell member may vary widely, and may be a function of a desired differential pressure profile. For example, the location of the reference pressure conduit 72 may calculated or empirically determined to produce a particular, optimal reference pressure in particular operating conditions of the blade.

In the embodiment of FIG. 16, common reference pressure headers 76 are provided for the pressure sensors 52 on suction side shell member 22, with the headers 76 in fluid communication with the external side of the opposite pressure side shell member 26. Likewise, common reference pressure headers 76 are provided for the pressure sensors 52 on the pressure side shell member 26, with such headers 76 in fluid communication with the external side of the opposite suction side shell member 22. It should be appreciated that various configurations of reference pressure headers 76 are contemplated.

With the embodiment of FIG. 15, the pressure sensors 52 produce signals that are indicative of the differential pressure between opposite sides of the blade 16 at generally the same relative chord position on the blade. As discussed, above the differential pressures need not be limited to the same relative chord position, and any desired reference pressure location may be used on the opposite side shell member. In the embodiment of FIG. 16, the reference pressure is taken at the communication point between the reference header 76 and the opposite side shell member, which is not necessarily at the same relative chord location as each of the sensors. This configuration may provide useful differential pressure measurements for certain control, monitoring, and testing functions.

The present invention also encompasses any configuration of a wind turbine 10 (FIG. 1) wherein at least one of the blades 16 is configured with the unique advantages of the invention as discussed above.

The present invention also encompasses various method embodiments for measuring air pressure of air that flows over the suction side or pressure side (or both of the suction and pressure sides) of a wind turbine blade 16. The method includes defining a passage 50 through a shell member 22, 26 that defines the respective suction side 20 or pressure side 24 (or both sides). This passage 50 may be defined during the fabrication step for the shell members wherein the passage is molded into the shell members. In alternative embodiments, the passage 50 may be formed into shell members in a post-fabrication process wherein the passage 50 is, for example, drilled through the shell member.

The method includes disposing a differential pressure sensor 52 in fluid communication with the passage 50 such that no part of the pressure sensor 52 extends onto an external surface 48 of the shell member 22, 26. For example, the pressure sensor 50 may be mounted to an internal surface 46 of the respective shell member such that a sensing element 56 configured with the pressure sensor 52 is exposed to external air pressure through the passage 50. In a particular embodiment, the sensing element 56 is disposed within the passage 50, for example, within a tubular member 68 of the pressure sensor 52 that is inserted into the passage 50.

The method includes providing for a second opposite side 60 of the sensing element 56 to be exposed to a steady state reference pressure corresponding to the air pressure within the internal cavity 40 of the blade 16. The differential pressure sensor 52 is used to generate an output signal that is indicative of the external air pressure.

The method also may include locating a plurality of the differential pressure sensors 52 in a defined pattern on each of or both of the suction side 20 and pressure side 22 of the blade 16, as discussed in detail above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A wind turbine blade, comprising:
a suction side shell member and a pressure side shell member, said shell members joined along a leading and trailing edge from a root to a tip of said blade and defining an internal cavity of said blade;
a pressure sensor configured on at least one of said suction side or said pressure side shell members, said pressure sensor further comprising:
a body mounted to an inner surface of said respective shell member within said internal cavity;
a sensing element having a first side exposed to external air pressure through a passage in said respective shell member, said sensing element having an opposite second side exposed to a reference pressure; and,
control circuitry within said body that generates a variable output signal as a function of a pressure differential between the external air pressure and reference pressure experienced by said sensing element.

2. The wind turbine blade as in claim 1, wherein said pressure sensor further comprises a tubular member extending from said body into said passage in said respective shell member, said tubular member having an open end in fluid communication with external air pressure, said sensing element disposed within said tubular member.

3. The wind turbine blade as in claim 2, wherein said open end of said tubular member is essentially flush with an external surface of said respective shell member.

4. The wind turbine blade as in claim 2, wherein said passage in said respective shell member is pre-formed, said tubular member inserted into said passage.

5. The wind turbine blade as in claim 1, wherein said pressure sensor further comprises a reference pressure conduit extending from said body and in fluid communication with said opposite second side of said sensing element, said reference pressure conduit in fluid communication with ambient air within said internal cavity such that said reference pressure is the ambient air within said internal cavity.

6. The wind turbine blade as in claim 1, wherein said pressure sensor further comprises a reference pressure conduit extending from said body and in fluid communication with said opposite second side of said sensing element, said reference pressure conduit in fluid communication with external air pressure at the opposite said shell member such that said reference pressure is the external air pressure acting on said opposite shell member.

7. The wind turbine blade as in claim 6, wherein said reference pressure conduit is in communication with a passage through said opposite shell member at a defined chord position to provide a desired reference pressure.

8. The wind turbine blade as in claim 1, wherein said pressure sensor is in wired or wireless communication with a controller, said controller using said output signal for control of a wind turbine parameter.

9. The wind turbine blade as in claim 1, further comprising a plurality of said pressure sensors arranged in a predetermined pattern on said suction side and said pressure side shell members.

10. The wind turbine blade as in claim 9, wherein said pattern comprises a plurality of spaced apart full chord-wise spans on each of said suction side and said pressure side shell members, said chord-wise spans distributed over one of: an entire axial length; an inner ⅓ axial section, a middle ⅓ axial section, or an outer ⅓ axial section of said blade.

11. The wind turbine blade as in claim 9, wherein said pattern comprises a plurality of spaced apart partial chord-wise spans on each of said suction side and said pressure side shell members.

12. The wind turbine blade as in claim 9, wherein said pressure sensors on said suction side and said pressure side shell members share a common reference pressure header.

13. The wind turbine blade as in claim 9, wherein said pressure sensors on said suction side shell member share a common reference pressure header, and said pressure sensors on said pressure side shell member share a separate common reference pressure header.

14. The wind turbine blade as in claim 9, further comprising a data acquisition terminal configured with said blade in communication with said plurality of pressure sensors, said data acquisition terminal configured to transmit signals corresponding to said pressure sensor output signals to an off-blade controller.

15. A wind turbine, comprising:
a plurality of wind turbine blades, at least one of said wind turbine blades further comprising
a suction side shell member and a pressure side shell member, said shell members joined along a leading and trailing edge from a root to a tip of said blade and defining an internal cavity of said blade;
a pressure sensor configured on at least one of said suction side or said pressure side shell members; said pressure sensor further comprising
a body mounted to an inner surface of said respective shell member within said internal cavity;
a sensing element having a first side exposed to external air pressure through a passage in said respective shell member, said sensing element having an opposite second side exposed to a reference pressure; and,
control circuitry within said body that generates a variable output signal as a function of a pressure differential experienced by said sensing element.

16. The wind turbine as in claim 15, wherein said pressure sensor further comprises a tubular member extending from said body into said passage in said respective shell member, said tubular member having an open end in fluid communication with external air pressure, said sensing element disposed within said conduit.

17. The wind turbine as in claim 16, wherein said pressure sensor further comprises a reference pressure conduit extending from said body and in fluid communication with said opposite second side of said sensing element, said reference pressure conduit in fluid communication with ambient air within said internal cavity such that said reference pressure is the ambient air within said internal cavity.

18. A method for measuring air pressure of air flowing over a suction side or pressure side of a wind turbine blade, comprising:
defining a passage through a shell member defining the respective suction side or pressure side;
disposing a pressure sensor in fluid communication with the passage such that no part of the pressure sensor extends onto an external surface of the shell member and a first side of a sensing element component of the pressure sensor is exposed to external air pressure through the passage;
providing for a second opposite side of the sensing element component to be exposed to a reference pressure; and,
generating an output signal from the pressure sensor that is indicative of the external air pressure.

19. The method of claim 18, further comprising defining the reference pressure as steady-state ambient air within an internal cavity of the blade.

20. The method of claim 18, further comprising locating a plurality of the pressure sensors in a defined pattern on each of the suction side and pressure side of the blade.
